(19) United States
(12) Patent Application Publication
(10) Pub. No.: US 2015/0298871 A1
(43) Pub. Date: Oct. 22, 2015

(54) Container and lid assembly

(71) Applicant: 9065-3395 QUEBEC INC., Saint-Denis-de-Brompton (CA)

(72) Inventor: Andre Charron, Saint-Denis-de-Brompton (CA)

(73) Assignee: 9065-3395 QUEBEC INC., Saint-Denis-de-Brompton (CA)

(21) Appl. No.: 14/545,305

(22) Filed: Apr. 20, 2015

Related U.S. Application Data
(60) Provisional application No. 61/981,705, filed on Apr. 18, 2014.
(60) Provisional application No. 61/981,705, filed on Apr. 18, 2014.

(51) Int. Cl. B65D 45/32; A47J 47/14; B65D 85/72; A47J 47/02

(52) U.S. Cl. CPC B65D 45/32; A47J 47/02; A47J 47/14; B65D 85/72

(57) ABSTRACT

The assembly (100) includes a container (102) and a lid (104). The container (102) includes a main body (110) and a container rim (120) surrounding the main body (110). The container rim (120) has an outer peripheral horizontal top surface (122) and an inner peripheral horizontal top surface (124). The outer peripheral horizontal top surface (122) surrounds the inner peripheral horizontal top surface (124) and is vertically below the inner peripheral horizontal top surface (124). The lid (104) includes a ring-shaped lid frame (130) and a membrane (132) that is attached over a top surface of the lid frame (130). The lid frame (130) includes a flat strip portion (134) having a continuous flat top surface and a continuous flat bottom surface, which bottom surface engages the outer peripheral horizontal top surface (122) when the lid (104) is in a closed position. The lid frame (130) also includes at least one latching tab (136, 138) that is made integral with an outer edge of the flat strip portion (134).

### TECHNICAL FIELD

The technical field relates generally to container and lid assemblies, for instance container and lid assemblies that can be used in the commercial food processing industry.

### TECHNICAL BACKGROUND

Various kinds of containers have been suggested over the years. Many containers designed for holding food include a main bottom section forming a tray, a dish, a bowl, a receptacle or the like, and each container is hermetically sealed around or near its top edges by a wrapping and/or a lid to protect the contents during the transportation, storage and handling. Some containers are sold to customers without any contents therein but others are sold together with food items, for instance as prepackaged meals or the like.

Designing food containers for the commercial food processing industry can be challenging. For instance, since most of these containers are only designed to hold food items until eaten by the customers, it is desirable that the quantity of materials required for making them and the manufacturing costs be minimized. Unfortunately, this is not always easy to achieve since the containers and their lids must also meet other requirements, such as resisting shipping, storage and handling, including handling at the stores or the restaurants where they are sold. The containers must remain intact and constantly sealed, between the packaging process and the moment customers open them, to avoid contamination and spoilage. On the other hand, adding too many packaging layers or features, such as a protective box made of cardboard or the like, or additional layers of wrapping, to mention just a few, increases the volume of waste material to be recycled and/or discarded after their use. This situation is not desirable and it will likely dissatisfy many actual or potential customers.

Further difficulties and challenges in the design of food containers are created when these food containers must also be used for heating/cooking food items directly therein, for instance in a microwave oven. In a microwave oven, the heat generated inside the food items is transferred to the container itself and the temperature of the container can eventually become very high. Containers must still remain sufficiently rigid even when heated at high temperatures.

Even more challenging is the design of food containers used for heating/cooking food items directly therein and that can be reclosed after the initial opening by the customer. These food containers are used with lids that can be reclosed during heating/cooking and/or afterwards for transportation and storage. For example, some prepackaged meals require separate ingredients to be mixed and/or added before heating/cooling them, such as a meal where water must be added before heating/cooking. Some meals can also be packaged with ingredients that must be mixed together by the customer inside the container but where not all ingredients are mixed at the same time. An example is a stir-fry meal where a sauce or the like is added only after some cooking/heating time. Still, physical interventions by the customer during the heating/cooking process, for instance to stir the content, may be another reason to have a reclosable lid. Other situations exist as well.

Containers must perform well in the hands of customers but they must also be easy to handle at the packaging end, for instance, by the packaging equipment. Some designs can be adequate for transportation, storage and handling but far less for the packaging process. Difficulties in handling containers and sealing their lids can increase costs and complexity of the packaging equipment and/or decrease the production rate.

Still, some container designs can create difficulties for the customers when they attempt to remove the sealed lid. Containers with rectilinear sides and relatively sharp corners are often difficult to handle when the lids are very light and flexible.

Unfortunately, none of the previously-suggested containers has proven entirely satisfactory to address many of the challenges encountered in the design of containers, particularly in the design of containers intended for the commercial food processing industry.

It is therefore clear that improvements in the related technical field are still and always be needed.

### SUMMARY

In a first aspect, there is provided an assembly that includes a container and a lid. The container includes a main body and a container rim surrounding the main body. The container rim has an outer peripheral horizontal top surface and an inner peripheral horizontal top surface. The outer peripheral horizontal top surface surrounds the inner peripheral horizontal top surface and is vertically below the inner peripheral horizontal top surface. The lid includes a ring-shaped lid frame and a membrane that is attached over a top surface of the lid frame. The lid frame includes a flat strip portion having a continuous flat top surface and a continuous flat bottom surface, which bottom surface engages the outer peripheral horizontal top surface when the lid is in a closed position. The lid frame also includes at least one latching tab that is made integral with an outer edge of the flat strip portion.

Although the container and lid assembly may be used for retaining many different products, the present invention is directed primarily to containers suitable for the food industry. Thus, the assembly includes a container and a corresponding lid therefore.

Many different shapes may be utilized as will be understood by those skilled in the art.

The materials conventionally are plastic materials and in one embodiment of the present invention, a thermoforming process is utilized to form the container. On the other hand, the lid frame may be injection molded.

The lid frame is utilized with a membrane which seats over the lid frame. The lid frame will include opposite corner latching tabs for sealing the same onto the container.

### BRIEF DESCRIPTION OF THE FIGURES

Having thus generally described the invention, reference will be made to the accompanying drawings illustrating embodiments thereof, in which:

FIG. 1 is an exploded isometric view of an example of a container and lid assembly based on the proposed concept;

FIG. 2 is an isometric view of the container and lid assembly in FIG. 1, where the assembly is illustrated in a closed position;

FIG. 3 is a top plan view of the container and lid assembly shown in FIG. 2;

FIG. 4 is a view similar to FIG. 2 but where the assembly is illustrated in an opened position as the lid is unconnected to the container;

FIG. 5 is an enlarged isometric view of the area inside line 5-5 in FIG. 4;

FIG. 6 is a transversal cross section view taken along line 6-6 in FIG. 2;

FIG. 7 is an enlarged view of the area inside line 7-7 in FIG. 6;

FIG. 8 is a semi-schematic view of an example of a mold in which the container and the lid frame are molded together; and

FIG. 9 is a cross-sectional view of a variation of a lid frame.

### DETAILED DESCRIPTION

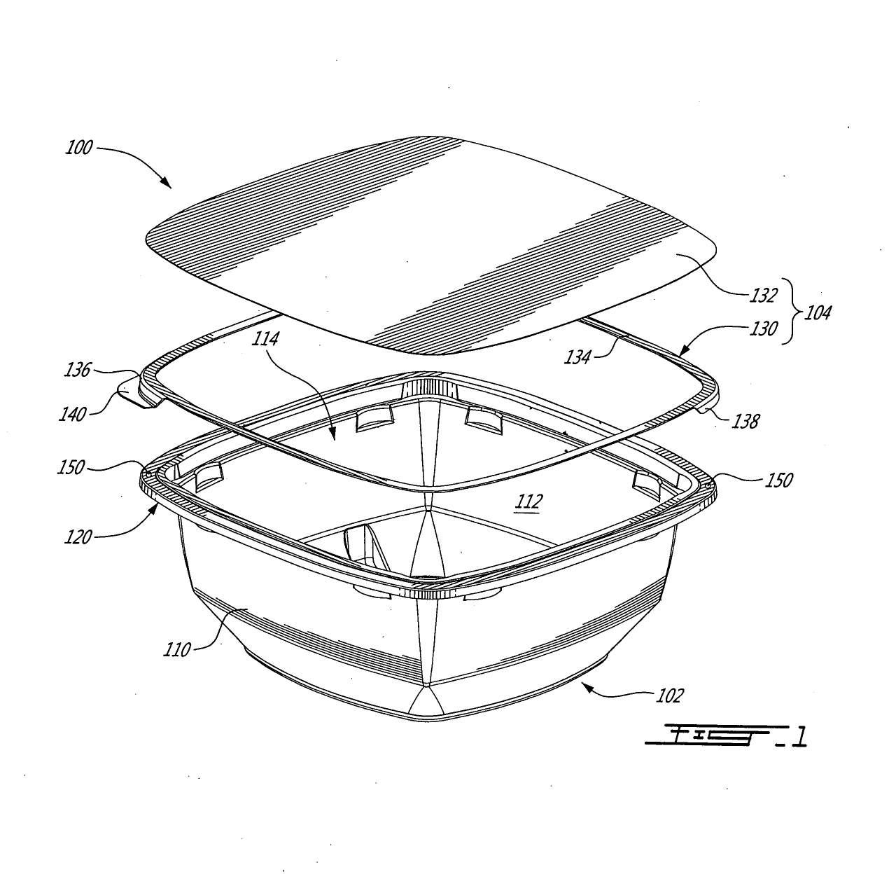

FIG. 1 is an exploded isometric view of an example of a container and lid assembly 100 based on the proposed concept. The assembly 100 is used for packaging a product, for instance one or more food items. Although the proposed concept is especially well adapted for holding meals and other food items, it is possible to design and/or use the assembly 100 for holding one or more products that are unrelated to the food industry. The following detailed description refers to the context of the commercial food processing industry only for the sake of simplicity.

As suggested by its name, the assembly 100 includes a container 102 and a corresponding lid 104. The container 102 includes a main body 110 having one or more walls defining a hollow interior compartment 112 for storing the food items to be packed therein. The container 102 has an opening 114 at the top that is defined by the inner edge of an outwardly-projecting container rim 120. The container rim 120 is made integral with the main body 110. The top of the container rim 120 is at the horizontal in normal use. The opening 114 is substantially rectangular in shape, with rounded corners and slightly curved sides between the corners. Variants are possible as well. For instance, the container 102 could have an opening with substantially straight sides and sharper corners, an opening with a nonrectangular shape, such as a rounded shape, a triangular shape or a shape with more than four sides, etc. Many other variants are possible as well.

In the illustrated example, the main body 110 includes a bottom wall and four upwardly-disposed side walls configured to form a bowl or the like. The wall or walls forming the main body 110 are airtight and liquid tight.

It should be noted that the shape of the main body 110 of the illustrated container 102 is only one example of implementation. Variants are possible.

The container 102 can be made using a thermoforming process or an injection molding process, for instance using a plastic material. Other materials and/or manufacturing processes can be used as well. The wall or walls forming the main body 110 of the container 102 can be relatively thin and the container rim 120 will stiffen the container 102, even if the container rim 120 is also relatively thin to minimize the quantity of material.

The lid 104 includes a ring-shaped lid frame 130 and a membrane 132 that will be attached over the lid frame 130 at some point of the packaging and/or manufacturing process. The lid frame 130 includes a relatively thin strip portion 134 having a continuous flat top surface and a continuous flat bottom surface. The periphery of the membrane 132 will adhere to the top surface of the lid frame 130 to form an airtight and liquid tight seal. The lid 104 is thus made with a minimized quantity of material and will be very light.

The lid frame 130 can be made using an injection molding process, for instance using a plastic material. Other materials and/or manufacturing processes can be used as well. However, the lid frame 130 is not molded directly to or over the container rim 120. The lid frame 130 is only put in position onto the container rim 120 after the molding process.

The membrane 132 is in the form of a thin film, for instance a plastic film or a foil. Other materials can be used as well, depending on the actual implementation. The membrane 132 can be transparent, translucent or opaque, depending on the needs.

The lid frame 130 of the illustrated example also includes two diametrically opposite corner latching tabs 136, 138 that are each made integral with the outer side edge of the lid frame 130. Each latching tab 136, 138 has a proximal section that extends outwards from the side edge of the strip portion 134 and a distal section that extends downwards. The latching tabs 136, 138 are designed to prevent them from interfering with the continuity of the contact of the bottom surface of the flat strip portion 134 with the outer peripheral top surface 122 when it rests thereon. The lid frame 130 of the illustrated example also includes a lift tab 140 that is made integral with the free end of the distal section of the first corner latching tab 136. Only one lift tab is provided in the illustrated example. The lift tab 140 extends horizontally outwards from the distal portion of the first corner latching tab 136. Variants are possible as well.

As can be seen, the lid 104 is devoid of a peripheral skirt or the like. The size of the latching tabs 136, 138 is also kept to a minimum. Overall, this will greatly facilitate the opening and closing of the lid 104. A lesser force is required to handle it and as a result, it is less likely to undergo a plastic deformation because the customer exerted an excessive pulling force. The lid frame 130 is relatively small and can be prone to deformation when subjected to an excessive pulling force.

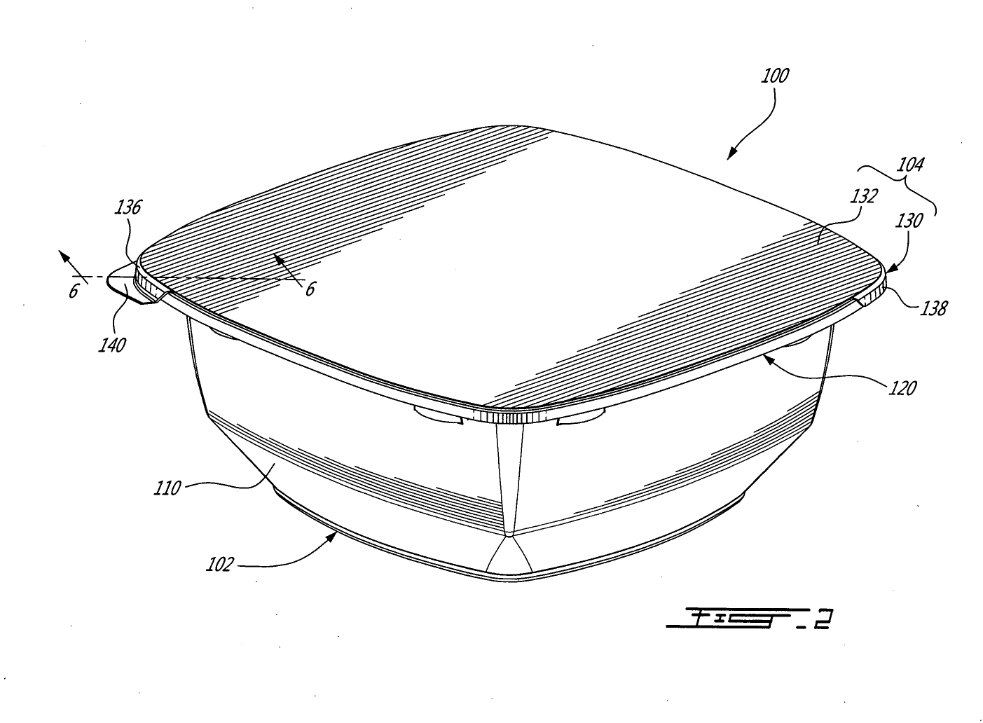

FIG. 2 is an isometric view of the container and lid assembly 100 in FIG. 1, where the assembly 100 is illustrated in a closed position. The lid 104 is then attached to the container 102, more specifically to the container rim 120. In FIG. 2, the membrane 132 is sealingly attached to the lid frame 130.

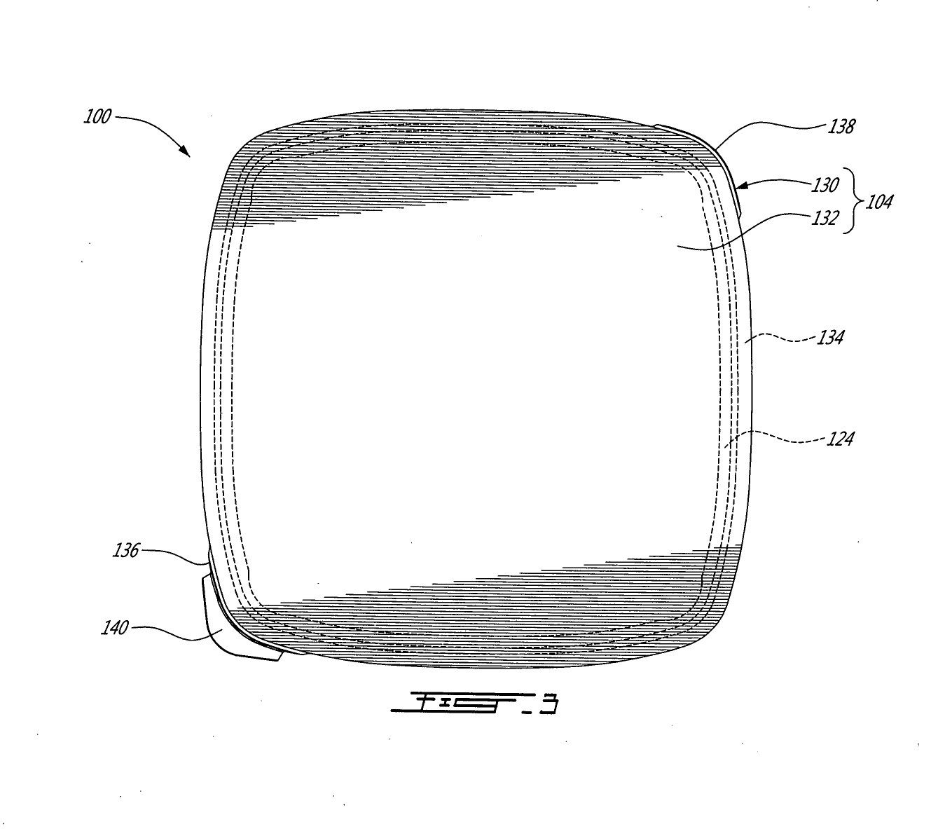

FIG. 3 is a top plan view of the container and lid assembly 100 shown in FIG. 2.

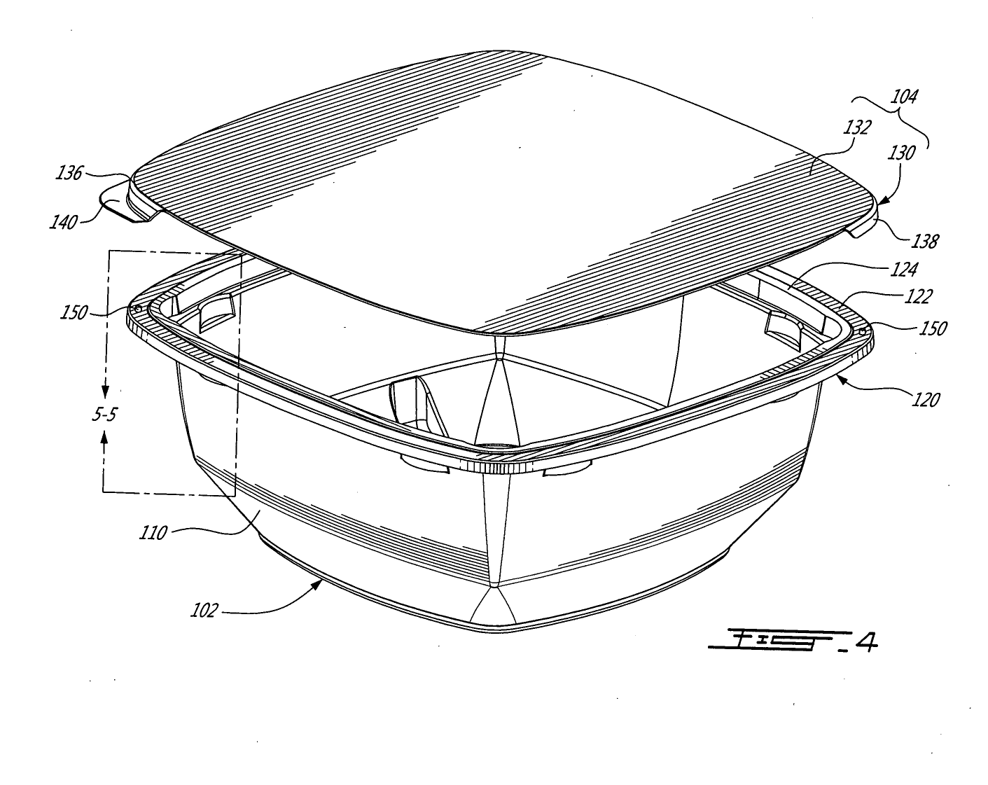

FIG. 4 is a view similar to FIG. 2 but where the assembly 100 is illustrated in an opened position. The lid 104 is then unconnected to the container 102.

As can be seen, for instance in FIGS. 3 and 4, the top side of the container rim 120 includes an outer peripheral top surface 122 and an inner peripheral top surface 124. Each of these surfaces 122, 124 are flat and continuous. They are also substantially horizontal in normal use. However, the outer peripheral top surface 122 is slightly vertically below the inner peripheral top surface 124 so as to receive the bottom surface of the lid frame 130 when the lid 104 is in a closed position. These mating surfaces are configured and disposed to form an uninterrupted seal around the entire perimeter of the container rim 120.

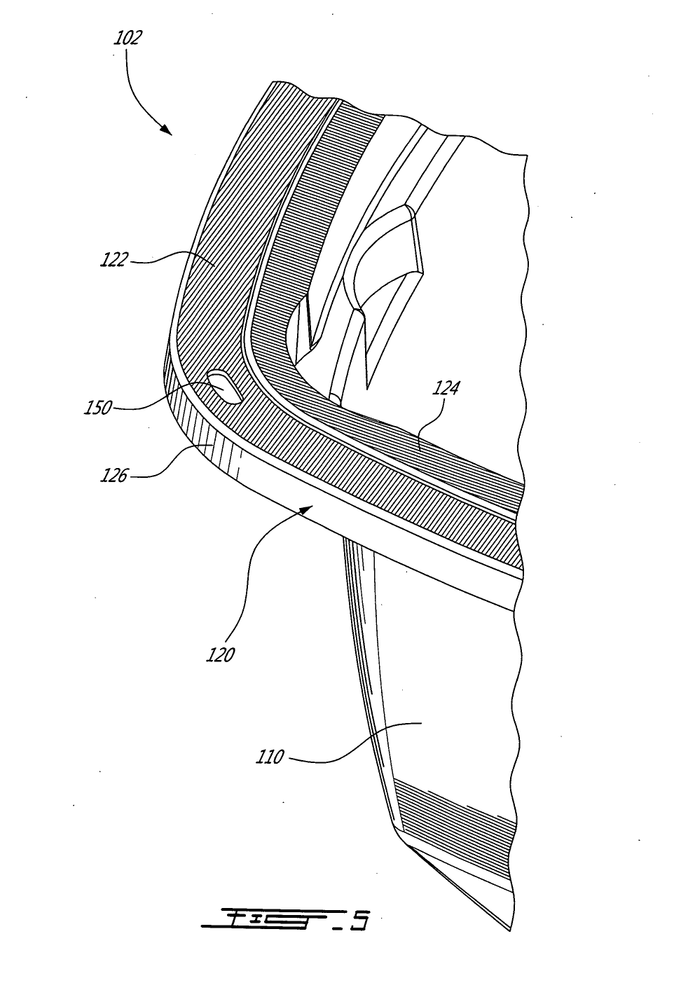

FIG. 5 is an enlarged isometric view of the area inside line 5-5 in FIG. 4. As can be seen, the outer peripheral top surface 122 includes a through hole 150 at the corner where the first latching tab 136 is located when the lid 104 is in a closed position. A similar hole 150 is also provided at the opposite corner, thus at the corner where the second latching tab 138 is located. In the illustrated example, these holes 150 have an oblong shape that is generally oriented parallel to the medial axis of the outer peripheral top surface 122. Variants are possible as well. For instance, the holes 150 can be provided with other shapes, including for instance a “lens” shape to help in aligning the studs 152 at the center of the holes 150.

FIG. 5 also shows that the container rim 120 of the illustrated assembly 100 includes a downwardly projecting skirt 126 extending around the entire periphery of the container 102. The skirt 126 promotes rigidity. Variants are possible as well.

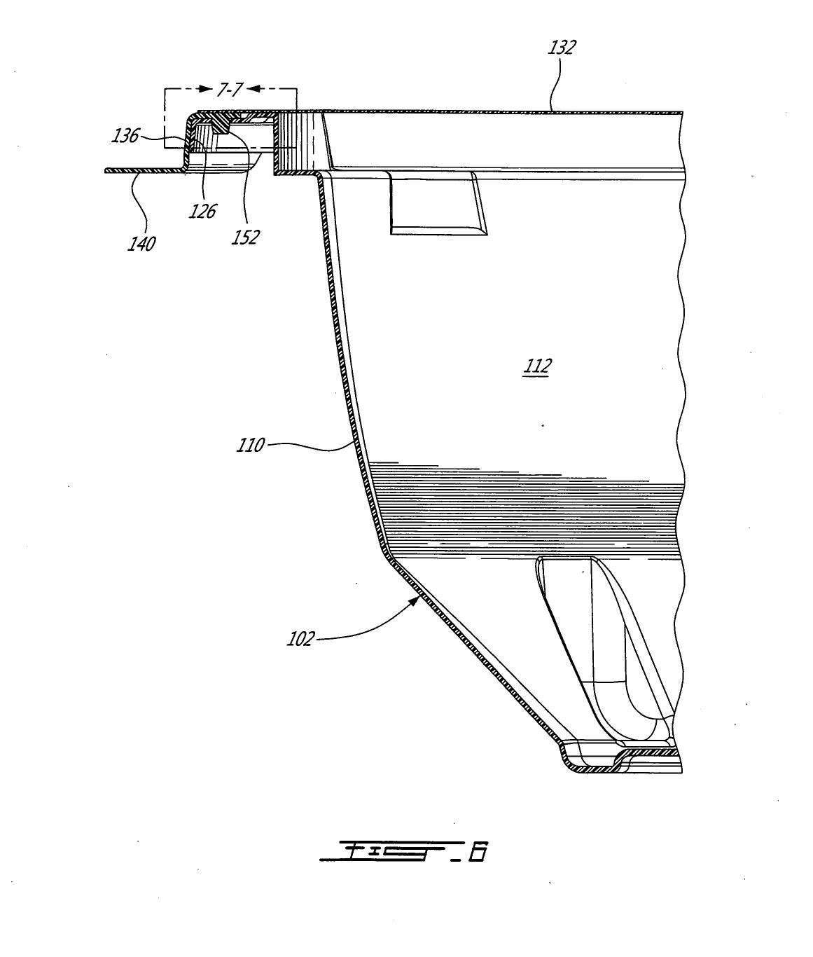

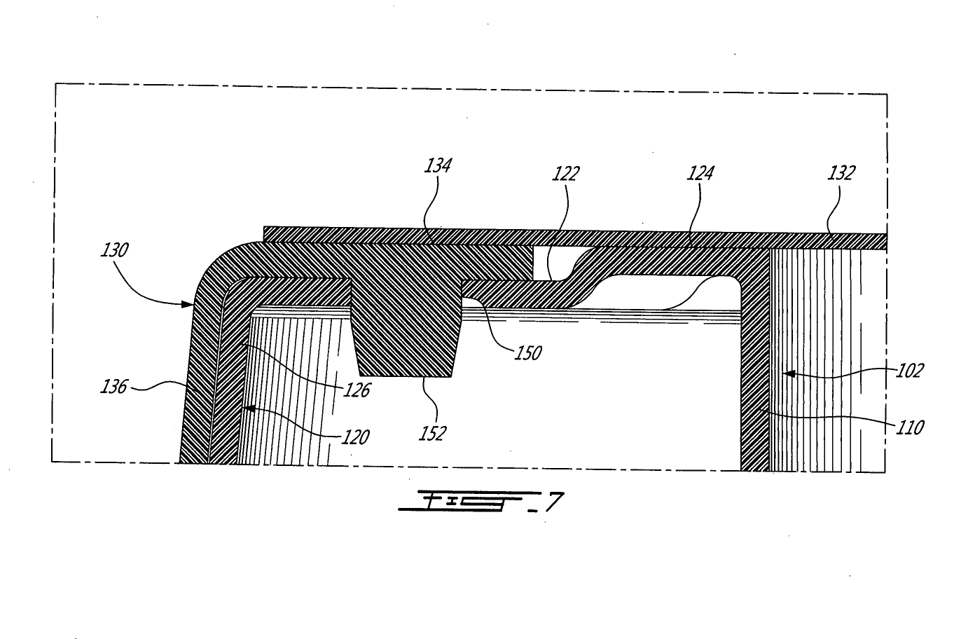

FIG. 6 is a transversal cross section view taken along line 6-6 in FIG. 2. It thus shows the lid 104 in a closed position. FIG. 7 is an enlarged view of the area inside line 7-7 in FIG. 6. As can be seen, these figures show one of the studs 152 provided to engage the inner edge of a corresponding hole 150, as best shown in FIG. 7. A similar stud 152 is provided at the opposite corner to engage the other hole 150. These studs 152 have a substantially circular cross section in the illustrated example. The engagement of the studs 152 with their corresponding holes 150 can be an interfering engagement, including for instance using a notch (not shown) or the like to create a snap fit interlocking connection. This removable interfering engagement will create a retention force resisting the lifting of the lid 104 and interlocking the lid 104 with the container 102. However, the interfering engagement can be removed upon lifting the lid frame 130 using a mild force. Using the studs 152 and the corresponding holes 150 also greatly facilitates the closing of the lid 104 since the lid frame 130 is made of a relatively flexible part. It can become very flexible at high temperatures and the studs 152 can facilitate the positioning. The customer can used their thumbs to urge the studs 152 into the holes 150 when closing the lid 104. Variants are possible as well.

The latching tabs 136, 138 also help in centering the lid 104 on the container 102 and they can be shaped to engage, with a mild interfering force, the bottom edge of the skirt 126. Each latching tab 136, 138 can be provided with an undercut (not shown) or a similar feature to create an interlocking connection with the bottom edge of the skirt 126. They can even replace the studs 152 and their holes 150 in some implementations. Variants are possible as well.

The holes 150 have an oblong shape in the illustrated example. This feature is to facilitate the positioning by the customer. Variants are possible as well.

FIG. 7 also shows that the top surface of the lid frame 130 and the inner peripheral top surface 124 of the container rim 120 are substantially flush with one another when the lid 104 is in a closed position. The bottom surface of the membrane 132 is then directly above the inner peripheral top surface 124.

Still, FIG. 7 shows that the inner side edge of the flat strip portion 134 is spaced apart from the outer edge bordering the inner peripheral top surface 124. This space can provide more room for aligning the parts when they are hot. The space also provides an increase of the manufacturing tolerances, thus mitigating the risks of having parts being rejected because they are too wide after the molding process.

During the packaging process, the item or items can be put inside the hollow interior compartment of each container 102 with the lid frame 130 being already in an interlocking engagement with the container rim 120. This previous step can be achieved by hand or by an appropriate equipment. The containers 102, with their lids 104 thereon, can still be stacked so as to minimize space. Variants as possible as well.

An interesting benefit of the proposed concept is that since no peripheral skirt is provided on the lid 104, the handling of the container 102 with the pre-connected lid frame 130 during the packaging process is made easier since a stack of these parts can be supported anywhere underneath the container rim 120, with the exception of the two corners with the latching tabs 136, 138 are provided, without the risks of accidentally lifting a portion of the lid frame 130 from the container rim 120.

The membrane 132 is added at the end of the packaging process to simultaneously form the lid 104 and to seal the whole assembly 100. For instance, if the membrane 132 is made of a thermoplastic material, the membrane 132 can be heated and pressure can be applied so as to simultaneously bond the outer perimeter of the membrane 132 to the outer and inner peripheral top surfaces 122, 124. This can be done in a single operation during which the underside of the container rim 120 is supported by a die while the membrane 132 is urged onto the lid frame 130 and onto the exposed inner peripheral top surface 124 by a heated pressure plate. The combination of heat and pressure bonds the membrane 132 over the top surface of the lid frame 130 and over the inner peripheral top surface 124.

If desired, the inner peripheral top surface 124 can be positioned slightly lower than the top surface of the flat strip portion 134 when the lid 104 is in a closed position. This will make the bond between the inner peripheral top surface 124 and the membrane 132 slightly weaker than the bond between the top surface of the flat strip portion 134 and the membrane 132. Still, as shown in FIG. 7, the width of the outer section of the membrane 132 that is fused onto the top surface of the flat strip portion 134 is larger than the width of the adjacent inner section of the membrane 132 that is fused onto the inner peripheral top surface 124. These features will make the membrane 132 less prone to detach from the lid frame 130 during the initial unsealing of the assembly 100 by the customer and will also decrease the required pulling force. This decrease of the pulling force can mitigate the risks of accidentally tearing the membrane 132 when the assembly 100 is unsealed. Variants are possible as well.

In use, to open the sealed assembly 100, the customer will move the lift tab 140 upwards to create a peeling force that will progressively detach the membrane 132 from the inner peripheral top surface 124 of the container rim 120, starting at the corner adjacent to the lifting tab 140. The membrane 132 will stay attached on the lid frame 130 since the peeling motion will only remove the membrane 132 from the inner peripheral top surface 124. Thus, it is relatively easy for the customer to lift a corner of the lid 104 using the lift tab 104 and then lift the whole lid 104 to access the interior of the container 102. This way, the customer can add liquids or other ingredients, for instance additional ingredients from a pouch or the like. The lid 104 can be reclosed before continuing the heating/cooking process.

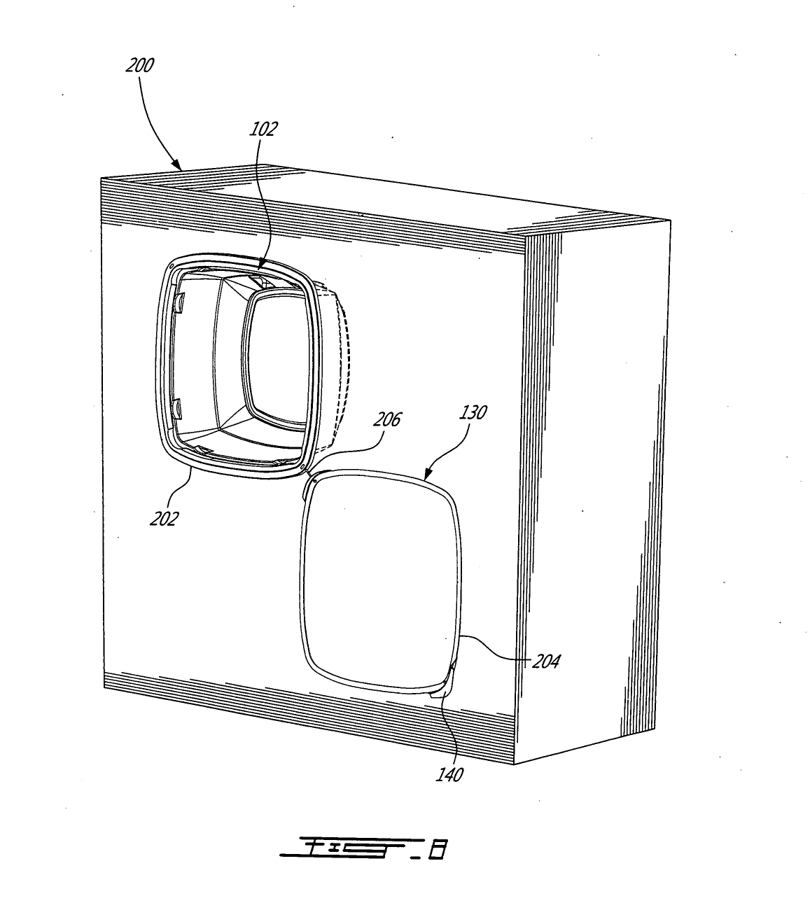

FIG. 8 is a semi-schematic view of a mold 200 in which the container 102 and the lid frame 130 15 are molded together in a same injection shot of molten plastic material but in separate cavities. The mold 200 includes a first cavity 202 for the container 102 and a second cavity 204 for the lid frame 130. Both cavities 202, 204 are in fluid communication using an intervening channel 206. The channel 206 will also be filled with the molten plastic material after the injection shot and as the plastic material solidifies, it will form a connector linking the outer edge of the container rim 120 to the outer edge of the lid frame 130. This connector 206 can be removed or cut to completely separate the container 102 and the lid frame 130. However, one can also keep the connector 206 to facilitate handling during the packaging and/or by the customer, provided that the connector 206 remains relatively flexible at room temperature and is located at the corner opposite the corner with the lift tab 140. The connector 206 can be useful for keeping the orientation of the lid frame 130 with reference to the container 102 and for preventing a customer from attempting to close the lid 104 while the studs 152 are at the corners where no holes are present.

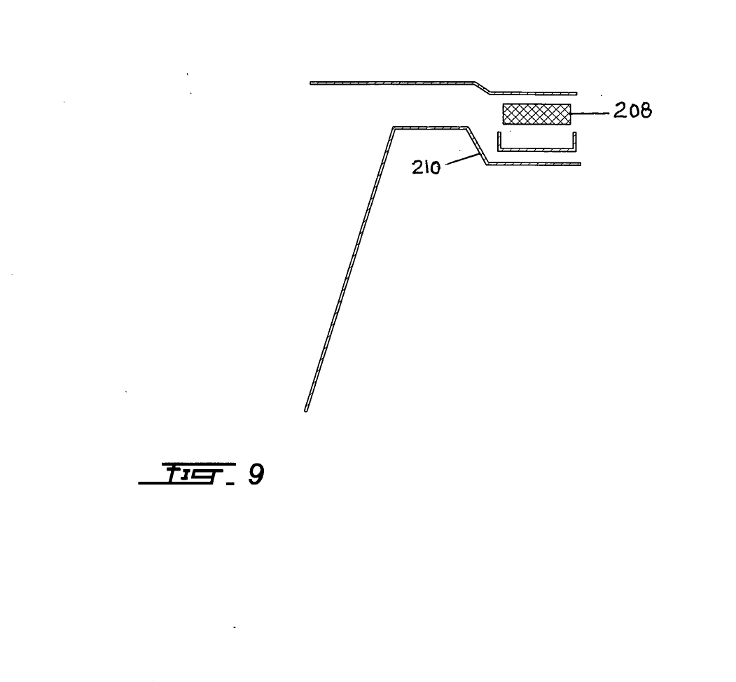

FIG. 9 illustrates an alternative embodiment in which an injection molded snap ring 208 is placed on top of a flange 210 to a thermoformed bowl. The flange 210 is welded to the thermoformed bowl. The ring can also be welded directly to the container so that when one opens the lid, the film will stick to the ring, but the ring will be detached from the container. The ring will also snap in the flange. Preferably, the flange and ring are injected molded.

The present detailed description and appended figures are only examples. A person working in this field will be able to see that variations can be made while still staying within the framework of the proposed concept.

### LIST OF REFERENCE NUMERALS

100 container and lid assembly
102 container
104 lid
110 main body (of container)
112 hollow interior compartment (of container)
114 opening (of container)
120 container rim
122 outer peripheral top surface
124 inner peripheral surface
126 skirt
130 lid frame
132 membrane
134 flat strip portion
136 first latching tab
138 second latching tab
140 lift tab
150 hole
152 stud
200 mold
202 first mold cavity
204 second mold cavity
206 channel/connector
208 snap ring
210 flange

What is claimed is:

1. A container and lid assembly (100) including:
a container (102), the container (102) including a main body (110) and a container rim (120) surrounding the main body (110), the container rim (120) having an outer peripheral horizontal top surface (122) and an inner peripheral horizontal top surface (124), the outer peripheral horizontal top surface (122) surrounding the inner peripheral horizontal top surface (124) and being vertically below the inner peripheral horizontal top surface (124); and
a lid (104), the lid (104) including:
a ring-shaped lid frame (130), the lid frame (130) including a flat strip portion (134) having a continuous flat top surface and a continuous flat bottom surface, which bottom surface engages the outer peripheral horizontal top surface (122) when the lid (104) is in a closed position, the lid frame (130) including at least one latching tab (136, 138) that is made integral with an outer edge of the flat strip portion (134); and
a membrane (132) attached over a top surface of the lid frame (130).

2. The container and lid assembly of claim 1 wherein said outer peripheral horizontal top surface (122) of said container rim includes at least one aperture being formed therein, said aperture being located at a corner of said outer peripheral horizontal top surface (122), said lid having a stud formed on said flat strip portion said stud being formed at a corner, said stud being designed to engage said aperture formed in said outer peripheral horizontal top surface.

3. The container and lid assembly of claim 2 wherein said aperture is of an oblong configuration.

4. The container and lid assembly of claim 3 wherein said stud has a cylindrical configuration.

5. The container and lid assembly of claim 1 wherein said container is thermoformed and said lid frame is injection molded.
